(19) United States
(12) Patent Application Publication
(10) Pub. No.: US 2006/0107109 A1
(43) Pub. Date: May 18, 2006

(54) Communication processing apparatus and method and program for diagnosing the same

(75) Inventor: Osamu Ikabata, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/262,737

(22) Filed: Nov. 1, 2005

(30) Foreign Application Priority Data
Nov. 1, 2004 (JP) 318361/2004

(51) Int. Cl. G06F 11/00

(52) U.S. Cl. 714/11

(57) ABSTRACT

The present invention makes it possible to detect abnormality in an error detecting function early while minimizing adverse effects on transfer performance. The present invention provides a method for diagnosing a transfer data ensuring system in which a transmitting apparatus transmits transmission data provided with an error detection code and then receives a result of error detection (referred to as a transfer reply below) carried out by a receiving apparatus to verify the transferred data, the method comprising transmitting dedicated diagnosis data provided with an incorrect error detection code and diagnosis data provided with a correct error detection data and diagnosing the error verifying function on the basis of a transfer reply to the transmitted data.

### BACKGROUND OF THE INVENTION

1. Field of the Invention

The present invention relates to a technique for serially transmitting packet data, and in particular, to a communication processing apparatus which transmits transmission data provided with an error detection code and which receives a result of error detection (referred to as a transfer reply below) carried out by a receiving apparatus to verify the transferred data, as well as a method and program diagnosing the communication processing apparatus.

2. Description of the Prior Art

In conventional data transmissions between electronic apparatuses, transmission data is transmitted to which an error detection code has been added. A receiving apparatus then carries out error detection (see, for example, Japanese Patent Laid-Open No. 62-195947). Examples of the error detecting scheme include parity, checksum, and a CRC scheme. The CRC scheme uses a polynomial into which a shift, an addition, and the like are combined to create a detection code so that transmission errors can be detected more reliably.

With apparatuses of this kind, as shown in FIG. 7, the receiver returns an affirmative reply if the result of the error check indicates that the packet data is normal. The receiver returns a negative reply if the result of the error check indicates that the packet data is abnormal. As shown in FIG. 8, upon receiving the affirmative reply from the receiver, the packet data transmitter transfers subsequent packet data. However, upon receiving the negative reply, the packet data transmitter transmits the above packet data again and waits for an affirmative reply. In this case, specified thresholds are used to monitor the period and number of retransmissions. If any of the thresholds is exceeded, the transmitter determines the serial transmission path to be abnormal. The transmitter then suspends the data transfer.

With another technique, the transmitter transmits only transfer data to the receiver. The receiver then generates error detection data from the received data and returns it to the transmitter. The transmitter then compares error detection data calculated by itself with the returned data to verify the validity of the data (see, for example, Japanese Patent Laid-Open No. 2000-341251).

Further, a technique has been proposed in which if a protocol process is debugged using a communication processing apparatus, an error frame is intentionally generated to allow the protocol to be verified easily and reliably (see, for example, Japanese Patent Laid-Open No. 7-123134).

However, with the conventional techniques, if a function for detecting an error in transmission data becomes abnormal, the abnormality is disadvantageously not detected early. That is, if, for example, CRC generating means of the transmitter becomes abnormal, CRC checking means in the receiver detects a mismatch in the transmission data. The receiver then returns a negative reply indicating this to the transmitter, which then executes a retransmission process. On this occasion, the retransmission process is monitored on the basis of specified limits on the number of retransmissions and the time required for the retransmission. The transmission data is not determined to be abnormal until all the retransmission processes observing the limits fail. Accordingly, it takes a long time to detect the abnormality.

Further, if, for example, the CRC checking means of the receiver becomes abnormal, the receiver returns a negative reply even with a correct CRC code added to the transmission data. The transmitter then executes a retransmission process. In this case, the abnormality is not reported until a specified number of retries have been finished or a specified period for the retries is over. Accordingly, it takes a long time to detect the abnormality. Furthermore, if a defect occurs in the CRC checking means of the receiver such that the CRC check indicates normality in spite of an actual transmission error, abnormal packet data are sequentially transferred without any report on the error. This may change the data received by the receiver.

Moreover, if ordinary transfer data is used to check the validity of the error detecting function, the transfer performance of the apparatus may be seriously affected. With ordinary transfer data, if the error detecting function is abnormal, a negative reply from the receiving apparatus causes the transmitting apparatus to execute a specified number of retransmission processes for a specified period. During this period, subsequent packet data cannot be transmitted. This may significantly delay data transmissions.

It is an object of the present invention to provide a communication processing apparatus, method, and program for diagnosing the same which operates in a communication processing apparatus adding an error detection code to transfer packet data to ensure the validity of the data, capable of immediately detecting abnormality to minimize adverse effects on transfer performance.

### BRIEF SUMMARY OF THE INVENTION

The present invention provides a communication processing apparatus which transmits transmission data provided with an error detection code and which then receives a result of error detection (referred to as a transfer reply below) carried out by a receiving apparatus to verify the transferred data, the apparatus being mainly characterized by transmitting data provided with an incorrect error detection code and data provided with a correct error detection data and diagnosing an error verifying function on the basis of a transfer reply to the transmitted data.

Desirably, the communication processing apparatus further comprises diagnosis data generating means for generating diagnosis packet data, and the apparatus diagnoses transmission data using the diagnosis data generated by the diagnosis data generating means.

Desirably, in a verification system in the communication processing apparatus the diagnosis means carries out diagnosis by transmitting data provided with a correct error code generated by normal code generating means in addition to transmitting data provided with an error detection code generated by abnormal code generating means and on the basis of two transfer replies to the transmitted data.

Desirably, the communication processing apparatus in accordance with the present invention further comprises trigger means for determining when to diagnose the apparatus, the trigger means starting diagnosing the apparatus every predetermined time and/or if a data transmission path has been idle for a predetermined period.

Further, desirably, the transfer reply returned by the receiving apparatus is checked on the basis of the error detection codes.

According to the present invention, the data is transmitted to which the incorrect error detection code has been added. Then, on the basis of the transfer reply to this data, the error verifying function is diagnosed. This makes it possible to diagnose CRC checking means of the receiving apparatus. That is, it is possible to detect a defect early such that the CRC checking means of the receiving apparatus determines the data to be normal in spite of a transmission error. The situation can be avoided in which data transfer is continuously carried out without detecting the error, resulting in changed data. In addition, the data is transmitted to which the correct error detection code has been added. Then, on the basis of the transfer reply to this data, diagnosis is carried out. This enables a single diagnosis operation to diagnose both CRC generating means in the transmitting apparatus and CRC checking means in the receiving apparatuses. Since no data transfer retries based on thresholds are required, a reliable system can be provided which detects abnormality early.

Further, the communication processing apparatus has the diagnosis data generating means to diagnose the error detecting function using the dedicated diagnosis data without using ordinary transfer data. This makes it possible to minimize the adverse effect on the transfer performance, thus providing a reliable system.

Furthermore, the error detecting function is set so as to carry out diagnosis every predetermined period. This avoids the situation in which diagnosis is periodically carried out with abnormality left undetected. Alternatively, diagnosis is carried out if the data transmission path has been idle for the predetermined period. This enables diagnosis to be carried out during the idle time without affecting the ordinary data transfer.

Moreover, the transfer reply from the receiving apparatus is checked on the basis of the error detection codes. This enables a single diagnosis to simultaneously diagnose both error detecting means in the transmitting apparatus and code generating means in the receiving apparatus. As a result, diagnosis can be efficiently carried out improve reliability.

### BRIEF DESCRIPTION OF THE DRAWINGS

FIG. 1 is a block diagram showing the configuration of a communication processing apparatus in accordance with an embodiment of the present invention;

FIG. 2 is a flowchart illustrating an example of operation of the communication processing apparatus in accordance with the present invention;

FIG. 3 is a flowchart illustrating an example of operation of the communication processing apparatus in accordance with the present invention;

FIG. 4 is a flowchart illustrating an example of operation of the communication processing apparatus in accordance with the present invention;

FIG. 5 is a flowchart illustrating an example of operation of the communication processing apparatus in accordance with the present invention;

FIG. 6 is a block diagram showing the configuration of a communication processing apparatus in accordance with another embodiment of the present invention;

FIG. 7 is a schematic diagram illustrating an operation of a conventional communication processing apparatus; and

FIG. 8 is a flowchart illustrating the operation of the conventional communication processing apparatus.

### DETAILED DESCRIPTION OF THE PREFERRED EMBODIMENTS

Embodiments of the present invention will be described below with reference to the drawings.

### Embodiment 1

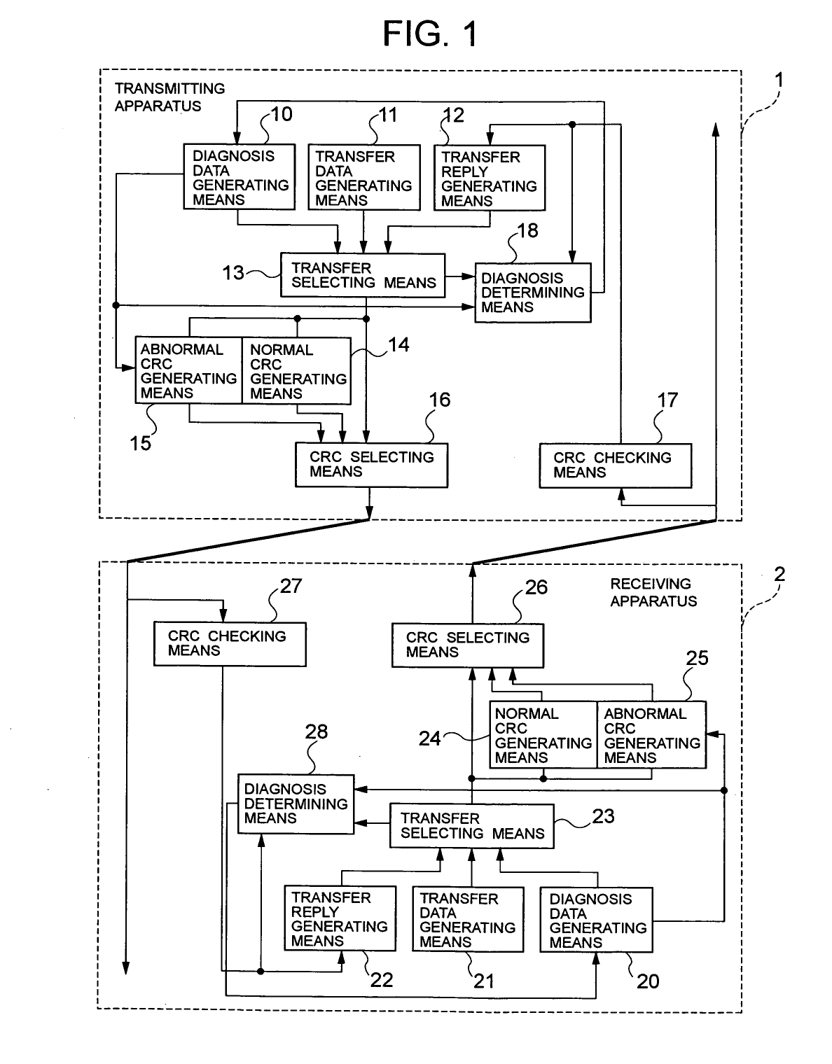

FIG. 1 is a block diagram showing the configuration of a communication processing apparatus in accordance with the present invention. For serial transmission, the apparatus in accordance with the present invention is suitably used for both a transmitter and a receiver as shown in FIG. 1. However, if the receiver has error detecting means using error detection codes, then the present invention may be applied only to the transmitter. In the description of the embodiments below, the CRC scheme is used for error detection. However, the present invention is not limited to the CRC, and another error detecting scheme such as the parity or checksum may be employed. FIG. 1 shows the configuration of an error detecting mechanism and its diagnosis mechanism in the apparatus. Communication processing apparatuses 1 and 2 comprise various other elements required for electronics such as computers.

As shown in FIG. 1, a communication processing apparatus 1 (transmitting apparatus) in accordance with the present invention comprises three data generating means, such as diagnosis data generating means 10, transfer data generating means 11, and transfer response generating means 12. Transfer selecting means 13 selects any of packet data from these three generating means and instructs the selected packet data to be transmitted to the receiving apparatus 2. The apparatus 1 also comprises normal CRC generating means 14 for generating a normal CRC for each transferred packet data, abnormal CRC generating means 15 for generating an abnormal CRC, CRC selecting means 16 for adding a CRC (code) generated by one of the CRC generating means 14 and 15 to packet data and then transmitting the packet data, CRC checking means 17 for carrying out CRC checks on the packet data received from the receiving apparatus 2, and diagnosis determining means 18 for diagnosing an error detecting function consisting of the above elements.

The communication processing apparatus 1 ensures transfer data by transmitting packet data provided with the CRC code and receiving a reply (transfer reply) from the receiver which contains the result of a CRC check carried out by the receiver. The communication processing apparatus 1 also uses the CRC checking means 18 to carry out error detection on the received transfer packet data. The communication processing apparatus 1 then uses the transfer reply generating means 12 to generate a transfer reply indicating the check result and returns the transfer reply to the source. The transfer reply is affirmative if the CRC check indicates that the data is normal. The transfer reply is negative if the transfer data does not correspond precisely to the CRC code.

The diagnosis data generating means 10 generates diagnosis packet data in response to an activation instruction from higher means (not shown). Here, desirably, software or firmware randomly creates diagnosis packet data, the size of which is smaller than that of ordinary transfer packet data. This enables the transmitting apparatus to quickly generate and add diagnosis data and a CRC to packet data and transmit the data to the receiving apparatus, while enabling the receiving apparatus to quickly return the result of a CRC check and a transfer reply. It is thus possible to minimize the adverse effect on the capability of transferring ordinary data. The higher means has a control section that controls the operation of the whole communication processing apparatus 1, an interface that transmits information input by an operator operating the communication processing apparatus 1, and transfer idle detecting means 30, activation time setting means 31, and the like in accordance with a second embodiment described below. The transfer data generating means 11 generates a transfer data packet by dividing ordinary data such as user data. The transfer reply generating means 12 generates a transfer reply (affirmative or negative reply) to packet data received by the apparatus 1. The transfer selecting means 13 selects any of packet data generated by the diagnosis data generating means 10, transfer data generating means 11, and transfer reply generating means 12. The transfer selecting means 13 determines whether to add a normal or abnormal CRC depending on the selected data source.

If the transfer selecting means 13 selects the diagnosis packet data generated by the diagnosis data generating means 10, the diagnosis data generating means 10 outputs a CRC generation instruction indicating whether to add a normal or abnormal CRC to the diagnosis packet data. If the CRC generation instruction indicates generation of a normal CRC, a normal CRC generated by the normal CRC generating means 14 is selected. On the other hand, if the CRC generation instruction indicates generation of an abnormal CRC, the transfer selecting means 13 selects an abnormal CRC generated by the abnormal CRC generating means 15. Here, CRC generation instructions from the diagnosis data generating means 10 indicate alternate outputs of a normal and abnormal CRCs or an abnormal and normal CRCs in this order. Whenever the transfer selecting means 13 selects ordinary transfer data or a transfer reply, which is different from diagnosis data, the normal CRC generated by the normal CRC generating means 14 is always selected. The CRC selecting means 16 adds the thus selected CRC code to the packet data and then transmits the data to the receiving apparatus 2.

If the transfer selecting means 13 selects diagnosis data, an expected value (referred to as a reply expectation below) for a transfer reply to the diagnosis packet data to be transferred is stored in the diagnosis determining means 18 in accordance with the CRC generation instruction (normal/abnormal) from the diagnosis data generating means 10. That is, the reply expectation is an affirmative reply if the normal CRC is selected, and the reply expectation is a negative reply if the abnormal CRC is selected. The diagnosis determining means 18 retains this reply expectation and compares it with a transfer reply subsequently returned by the receiving apparatus 2 to diagnose the error detecting mechanism.

The receiving apparatus 2 has a configuration similar to that of the transmitting communication processing apparatus 1. However, description will be given of elements required for operations of the present embodiment. When the transmitting apparatus 1 transmits packet data as described above, CRC checking means 27 in the receiving apparatus 2 carries out error detection on the serially transmitted packet data. The result of the detection is transmitted to transfer reply generating means 22, which then generates a transfer reply and returns it to the transmitting apparatus. In this case, if the CRC of the packet data received by the receiving apparatus 2 is normal, an affirmative reply is returned. If the CRC is abnormal, a negative reply is returned. Regardless of whether the transfer reply is affirmative or negative, transfer selecting means 23 of the receiving apparatus 2 selects normal CRC generating means. Thus, the normal CRC is always added to the transfer reply, which is then returned to the transmitting apparatus 1.

The CRC checking means 17 of the transmitting apparatus 1 carries out error detection on the transfer reply returned by the receiving apparatus 2. The result of the detection and the content (affirmative or negative) of the transfer reply are transmitted to the diagnosis determining means 18. The diagnosis determining means 18 compares the received transfer reply with the transfer expectation stored when the diagnosis packet data was transmitted. If the transfer reply matches the transfer expectation, the error detecting mechanism determines the data to be normal. If the transfer reply is different from the transfer expectation, the error detecting mechanism determines the data to be abnormal. If the received data is ordinary transfer data or diagnosis data, the CRC checking means 17 notifies the transfer reply generating means 12 of this. The transfer reply generating means 12 then generates a transfer reply. On the other hand, if the received data is a transfer reply, no notifications are given to the transfer reply generating means 12. Therefore, no transfer replies are returned.

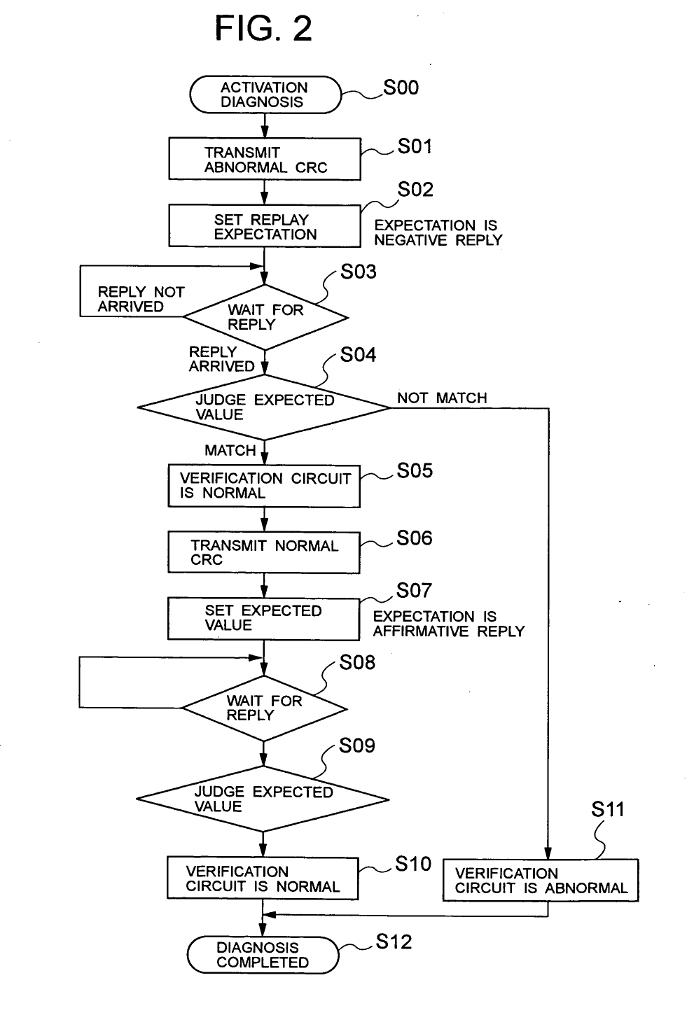

Description will be given of operations of the communication processing apparatus 1, configured as described above. FIG. 2 is a flowchart illustrating a diagnosis operation performed by the error detecting mechanism of the apparatus 1. Upon receiving an activation instruction (step S00), the diagnosis data generating means 10 generates diagnosis packet data and a CRC generation instruction (normal or abnormal). The diagnosis data generating means 10 then outputs the data and instruction to the transfer selecting means 13 (step Sol). The transfer selecting means 13 receives packet data from the diagnosis data generating means 10, transfer data generating means 11, and transfer reply generating means 12. The transfer selecting means 13 then carries out arbitration based on the priorities of requests or the like. The transfer selecting means 13 thus selects and outputs any of the packet data. If diagnosis packet data is selected, the transfer selecting means 13 notifies the diagnosis determining means 18 of this. Upon receiving the notification, the diagnosis determining means 18 stores the diagnosis packet data and the reply expectation determined by the CRC added to it with reference to the CRC generation instruction output by the diagnosis data generating means 10 (step S02). In this case, the CRC generation instruction may be normal or abnormal. However, in the present embodiment, a CRC generation instruction is given which instructs the abnormal CRC to be first added to the data. Therefore, the replay expectation retained by the diagnosis determining means 18 corresponds to a negative reply.

Accordingly, the abnormal CRC generating means 15 generates an abnormal CRC not corresponding to the diagnosis data. The CRC selecting means 16 adds the abnormal CRC to the diagnosis packet data and then transmits the data to the receiving apparatus 2. After transmitting the diagnosis packet data, the diagnosis determining means 18 waits for the corresponding transfer reply from being returned (step S03). If the transfer selecting means 13 selects data different from the diagnosis packet data, a normal CRC is generated and added to the selected data, which is then transmitted.

The CRC checking means 27 in the receiving apparatus 1 carries out error detection on the diagnosis packet data transmitted by the transmitting apparatus 1. In this case, the CRC for the diagnosis packet data transmitted by the transmitting apparatus 1 is equal to that generated by the abnormal CRC generating means 15. Consequently, in the error detection, the CRC checking means 27 in the receiving apparatus 2 determines the data to be abnormal. The CRC checking means 27 in the receiving apparatus 2 notifies the transfer reply generating means 22 of this. This causes a negative reply to be returned to the transmitting apparatus 1. A CRC generated by normal CRC generating means 24 is added to the returned transfer reply.

The transmitting apparatus 1 uses the CRC checking means 27 to carry out a CRC check on the received packet data. Upon determining that the packet data is a transfer reply to the diagnosis packet data, the transmitting apparatus 1 notifies the diagnosis determining means 18 of the content of the reply. The diagnosis determining means 18 compares the content of the transfer reply with the reply expectation stored when the diagnosis packet data was transmitted (step S04). As previously described, the replay expectation for the diagnosis packet data transmitted with the abnormal CRC added is a negative reply. However, contrary to this if the content of the transfer reply is an affirmative reply diagnosis, the diagnosis determining means 18 determines that the CRC generating means 14 and 15 in the transmitting apparatus or the CRC checking means 27 in the receiving apparatus 2 is abnormal (step S11). On the other hand, if the transfer reply matches the stored reply expectation, the diagnosis determining means 18 instructs the diagnosis data generating means 10 to be reactivated.

If the CRC checking means 17 in the transmitting apparatus 1 is abnormal, the transfer data is not determined to be normal in spite of the transfer reply from the receiving apparatus 2. Consequently, no transfer replies are transmitted to the diagnosis determining means 18. To detect this, the diagnosis determining means 18 may use a timer to monitor the return of a transfer reply following the transmission of diagnosis packet data. When the transfer reply fails to reach the apparatus within a predetermined period, the diagnosis determining means 18 may determine that the transmitting or receiving CRC checking means 17 or 27 or the CRC generating means 24 in the receiving apparatus 2 is abnormal. Alternatively, if the result of CRC error detection carried out on the transfer reply by the CRC checking means 17 indicates abnormality, the diagnosis determining means 17 may be notified of this. In this case, the diagnosis determining means 17 determines that the normal CRC generating means in the receiving apparatus 2 is abnormal.

Upon receiving the reactivation instruction, the diagnosis data generating means 10 generates diagnosis packet data and outputs a CRC generation instruction on addition of the normal CRC. The transfer selecting means 13 selects the diagnosis packet data, provided with the normal CRC generated by the normal CRC generating means 14. The packet data is then transmitted to the receiving apparatus 2 (step S06). At the same time, the diagnosis determining means 18 is notified of this and stores an affirmative reply as a reply expectation (step S07). After transmitting the diagnosis packet data, the transmitting apparatus 1 waits for a transfer reply from the receiving apparatus 2 (step S08).

The receiving apparatus 2 carries out a CRC check on the transmitted data and returns an affirmative or negative reply depending on the result of the check. Upon receiving the transfer reply, the transmitting apparatus 1 carries out a CRC check. The transmitting apparatus 1 determines that the received data is a transfer reply and notifies the diagnosis determining means 18 of the content of the reply. The diagnosis determining means 18 compares the stored reply expectation (affirmative reply) with the transfer reply (step S09). If the replay expectation does not match the transfer replay, the diagnosis determining means 18 determines that the CRC generating means 14 and 15 in the transmitting apparatus or the CRC checking means 27 in the receiving apparatus 2 is abnormal (step S11). On the other hand, if the replay expectation matches the transfer replay, the diagnosis determining means 18 determines that the error detecting mechanism is normal. The diagnosis process is thus completed (step S12).

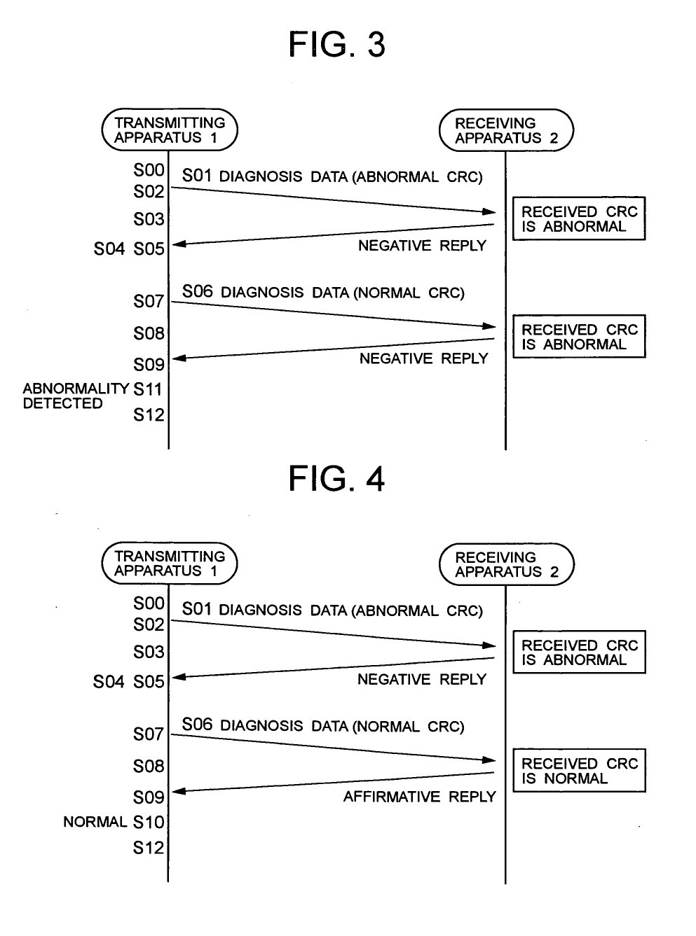

A specific example will be described with reference to FIGS. 3 to 5. FIG. 3 is a flowchart illustrating the normal CRC generating circuit 14 in the transmitting apparatus 1 is abnormal. The key reference numerals shown in the figure show the steps in FIG. 2. First, diagnosis packet data is transmitted to which an abnormal CRC generated by the abnormal CRC generating means 15 has been added (S01). The receiving apparatus 2 then carries out a CRC check on the packet data to determine that the data is abnormal. Consequently, a negative transfer reply is returned to the transmitting apparatus 1. Then, the diagnosis determining means 18 makes determination. In this case, the reply expectation is also negative and thus matches the transfer reply (S04, S05). This causes the diagnosis data generating means 10 to be reactivated to output diagnosis packet data together with an instruction on addition of a normal CRC. However, in the present example, the normal CRC generating means 14 is abnormal, so that the diagnosis packet data is transmitted without the correct CRC (S06).

The receiving apparatus 2 carries out a CRC check on the received packet data and determines the diagnosis packet data to be abnormal. Thus is due to the addition of an incorrect CRC. This result is transmitted to the transfer reply generating means 22, with a negative reply returned to the transmitting apparatus 1 as a transfer reply. The diagnosis determining means 18 in the transmitting apparatus 1 compares the transfer reply with the stored reply expectation. The reply expectation is affirmative, whereas the transfer reply is negative. Consequently, the comparison shows that the reply expectation is different from the transfer reply, thus detecting that the normal CRC generating means 14 in the transmitting apparatus 1 is abnormal.

In contrast, if the normal CRC generating means 14 in the transmitting apparatus 1 is normal, an affirmative transfer reply is provided for the diagnosis packet data provided with the CRC generated by the normal CRC generating means 14. Consequently, the transfer reply matches the reply expectation in the transmitting apparatus 1. The diagnosis determining means 18 determines that the error detecting mechanism is normal. The diagnosis process is thus completed (FIG. 4).

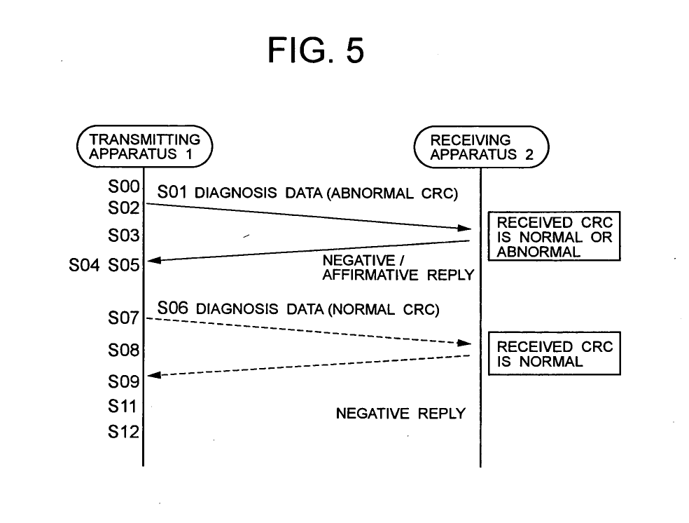

FIG. 5 is a diagram illustrating operations performed if the CRC checking means 27 in the receiving apparatus 2 becomes abnormal. For diagnosis, the transmitting apparatus 1 first transmits diagnosis packet data provided with an abnormal CRC (S01). The CRC checking means 27 in the receiving apparatus 2 then carries out error detection on the diagnosis packet data. In this case, if the CRC checking means 27 is abnormal, the correct CRC error check cannot be carried out. Accordingly, the check result corresponds to a false determination indicating abnormality or normality. An affirmative or negative reply is thus returned. A negative reply is stored in the diagnosis determining means 18 in the transmitting apparatus 1 as a reply expectation. Thus, if an affirmative replay is returned, it does not match the reply expectation. The receiving apparatus 2 thus detects that the CRC checking means 27 in the receiving apparatus 2 is abnormal.

On the other hand, if a negative reply is returned, the process advances to step S06 to reactivate the diagnosis data generating means 10. The transmitting apparatus 1 transmits diagnosis packet data provided with a normal CRC. The CRC checking means 27 in the receiving apparatus 2 carries out an error check. However, the CRC checking means 27 cannot carry out a normal check and the result of the check indicates abnormality. A negative reply is thus returned. The CRC checking means 17 in the transmitting apparatus 1 carries out a CRC check and determines that the received data is a transfer reply to the diagnosis packet data. The CRC checking means 17 outputs the content of the reply to the diagnosis determining means 18. In this case, the reply expectation retained in the diagnosis determining means 18 is affirmative and does not match the received negative transfer reply. The diagnosis determining means 18 then determines that the CRC generating means 14 and 15 in the transmitting apparatus 1 or the CRC checking means 27 in the receiving apparatus 2 is abnormal (step S9). In this manner, the transmitting apparatus 1 can detect that the CRC checking means 27 in the receiving apparatus 2 is abnormal.

As described above, diagnosis packet data to be different reply expectations is provided in a set. The reply expectation is stored when the diagnosis packet data is transmitted. The reply expectation is then compared with a returned transfer reply. This makes it possible to diagnose the CRC generating means in the transmitting apparatus and the CRC checking means in the receiving apparatus 2. Further, a CRC check is carried out on the transfer reply returned by the receiving apparatus 2. This makes it possible to diagnose the CRC checking means 17 in the transmitting apparatus 1 and the normal CRC generating means 24 in the receiving apparatus 2 for abnormality. Therefore, a single diagnosis operation enables efficient diagnosis of both CRC checking means and CRC generating means in each of the transmitter and receiver. The validity of the system including the data transmission path can be verified.

The components shown in FIG. 1 may be formed into a unit on a circuit board in the transmitting apparatus 1. However, the components may be configured as modules in firmware or software for electronics comprising a data communication function. In particular, the diagnosis data generating means 10 can be activated using firmware or software, and diagnosis packet data may be generated by firmware or the like. Which configuration is to adopt may be determined depending on an implementation environment. Those skilled in the art can easily make this determination and its detailed description is thus omitted.

### Embodiment 2

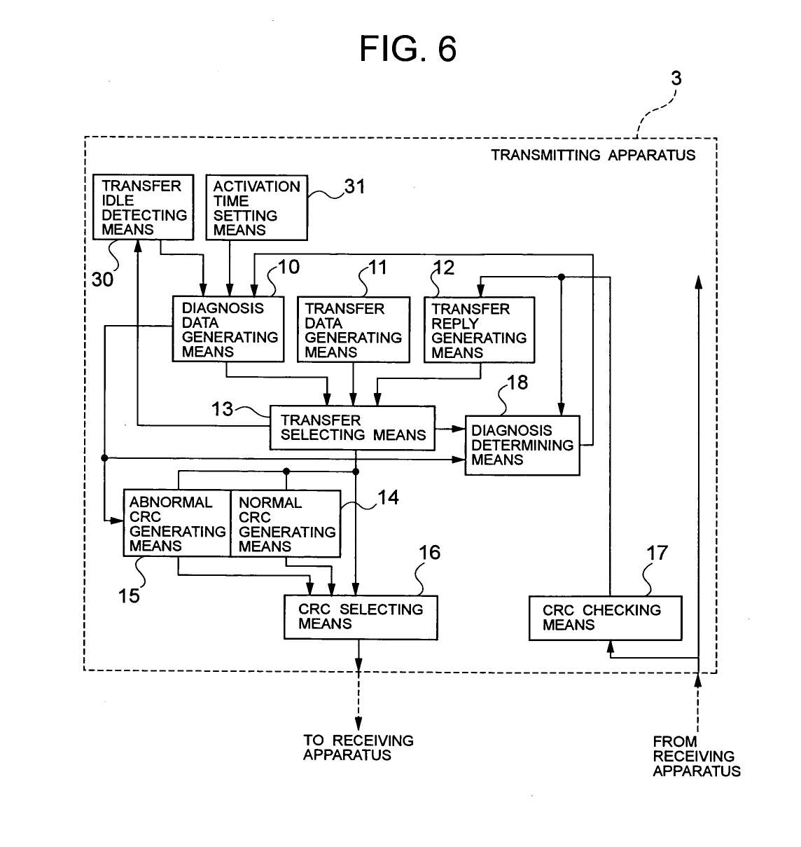

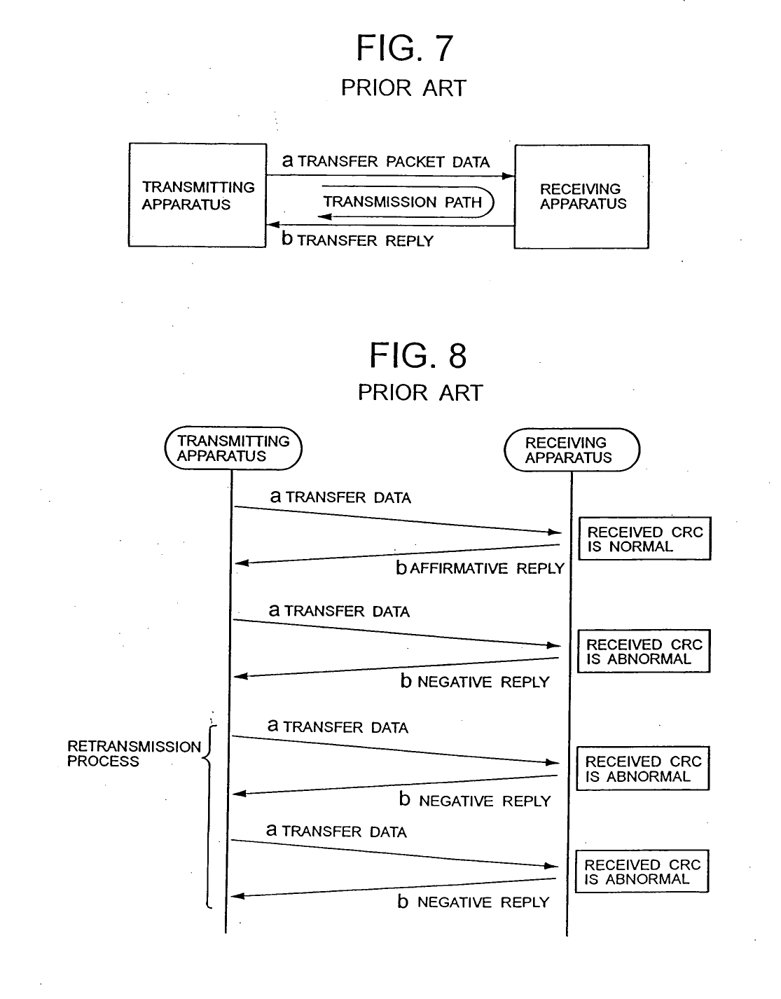

FIG. 6 is a diagram showing the configuration of a second embodiment of a communication processing apparatus in accordance with the present invention. The basic configuration of the present embodiment is similar to that of the first embodiment shown in FIG. 1. However, in the present embodiment, the activation of diagnosis data is improved compared to that in the first embodiment. As shown in FIG. 6, a communication processing apparatus 3 (transmitting apparatus) in accordance with the present embodiment comprises transfer idle detecting means 30 and activation time setting means 31 in addition to the configuration of the communication processing apparatus 1 shown in FIG. 1.

The following is input to the transfer idle detecting means 30: the state of transmission of packet data from the transfer selecting means 13 or CRC selecting means 16 to the serial transmission path. The transfer idle detecting means 30 activates the diagnosis data generating means 10 to start a diagnosis process if no packet data has been transmitted to the serial transmission path or if no data has been transmitted for a specified period. The activation time setting means 31 activates the diagnosis data generating means 10 at set times and/or at predetermined intervals to start a diagnosis process.

By thus providing means for determining when to start a diagnosis process, it is possible to automatically diagnose the error detecting function immediately after the communication processing apparatus 1 has been activated or while the data transmission path is idle. This provides an apparatus that minimizes the adverse effect on ordinary data transfers while improving the transfer performance.

In the present embodiment, the transfer idle detecting means 30 and/or activation time setting means 31 may be composed of firmware or software. Further, the apparatus 1 may comprise only one of the transfer idle detecting means 30 and the activation time setting means 31. Additionally or alternatively, means may be provided to which an output signal from the CRC checking means 17 is input and which activates the diagnosis data generating means 10 if a negative transfer reply is provided during data transfer. If the apparatus is thus diagnosed as soon as a transfer error has occurred, the abnormality can be detected earlier than in the case where the abnormality is determined after several retry processes.

The embodiments of the present invention have been described in detail. However, the technical scope of the present invention is not limited to the configurations of the above embodiments. Various embodiments may be carried out within the limits set forth in the claims.

The communication processing apparatus and the method and program for diagnosing the communication processing apparatus can detect abnormality in the error detecting function early while minimizing the adverse effect on the transfer performance. Therefore, the communication processing apparatus and the method and program for diagnosing the communication processing apparatus are useful for the communication apparatus, such as network communication apparatuses and cellular phones.

What is claimed is:

1. A communication processing apparatus which transmits transmission data provided with an error detection signal, wherein an error detecting function is diagnosed by transmitting and storing data provided with an incorrect error detection code and comparing the stored data with a result of error detection returned by a receiving apparatus.

2. The communication processing apparatus according to claim 1, wherein the error detecting function is diagnosed by transmitting, during the diagnosis, data provided with a correct error code in addition to the data provided with the incorrect error detection code.

3. The communication processing apparatus according to claim 1, wherein the error detecting function is diagnosed using diagnosis packet data separately provided for diagnosis.

4. The communication processing apparatus according to claim 1, wherein the error detecting function is diagnosed every predetermined period and/or if a data transmission path has been idle for a predetermined period and/or if a transmission error is detected during data transfer.

5. A communication processing apparatus which transmits transmission data provided with an error detection code and which then receives a result of error detection (referred to as a transfer reply below) carried out by a receiving apparatus to verify the transferred data, the apparatus comprising normal code generating means for generating a correct error detection code, abnormal code generating means for generating an incorrect error detection code, selecting means for selectively adding to transmission data the error detection code generated by the normal code generating means or abnormal code generating means, and diagnosis means for diagnosing the apparatus on the basis of the transfer reply returned by the receiving apparatus.

6. The communication processing apparatus according to claim 5, wherein the diagnosis means diagnoses the apparatus by temporarily retaining the result of the selection made by the selecting means and comparing the transfer reply returned by the receiving apparatus with the retained selection result.

7. The communication processing apparatus according to claim 5, further comprising error detecting means for checking the transfer reply returned by the receiving apparatus on the basis of the error detection code.

8. The communication processing apparatus according to claim 5, further comprising diagnosis data generating means for generating diagnosis packet data,
wherein the apparatus is diagnosed using the diagnosis data generated by the diagnosis data generating means.

9. The communication processing apparatus according to claim 5, wherein transmission data provided with the error detection code generated by the normal code generating means is transmitted in addition to transmission data provided with the error detection code generated by the abnormal code generating means, and the diagnosis means diagnose the apparatus on the basis of the two transfer replies.

10. The communication processing apparatus according to claim 5, further comprising trigger means for determining when to diagnose the apparatus, the trigger means starting diagnosing the apparatus every predetermined time and/or if a data transmission path has been idle for a predetermined period.

11. The communication processing apparatus according to claim 5, further comprising trigger means for determining when to diagnose the apparatus, the trigger means starting diagnosing the apparatus if the apparatus means receives a negative transfer reply from the receiving apparatus during an ordinary data transfer.

12. A method for diagnosing a transfer data ensuring system in which a transmitting apparatus transmits transmission data provided with an error detection code and which then receives a result of error detection (referred to as a transfer reply below) carried out by a receiving apparatus, wherein the method comprises transmitting data provided with an incorrect error detection code and data provided with a correct error detection data and diagnosing an error verifying function on the basis of a transfer reply to the transmitted data.

13. The method for diagnosing a transfer data ensuring system according to claim 12, wherein the data transmitted during the diagnosis is separately provided for the diagnosis.

14. The method for diagnosing a transfer data ensuring system according to claim 12, wherein the diagnosis is carried out every predetermined period and/or if a data transmission path has been idle for a predetermined period.

15. A program for diagnosing a communication processing apparatus which transmits transmission data provided with an error detection code and which then receives a result of error detection (referred to as a transfer reply below) carried out by a receiving apparatus to verify the transferred data, wherein the communication processing apparatus is caused to transmit data provided with an incorrect error detection code and data provided with a correct error detection data and to diagnose an error verifying function on the basis of a transfer reply to the transmitted data.

16. The diagnosis program according to claim 15, wherein diagnosis packet data is generated so that the communication processing apparatus is caused to carry out the diagnosis using the data generated.

17. The diagnosis program according to claim 15, wherein the processing apparatus is caused to carry out the diagnosis every predetermined period and/or if a data transmission path has been idle for a predetermined period.
